(19) United States
(12) Patent Application Publication
(10) Pub. No.: US 2009/0022543 A1
(43) Pub. Date: Jan. 22, 2009

(54) File folder extender

(76) Inventor: Lance R. Pyle, Citrus Heights, CA (US)

Correspondence Address: MATHEW J. TEMMERMAN, 423 E. STREET, DAVIS, CA, 95616, US

(21) Appl. No.: 11/879,847

(22) Filed: Jul. 18, 2007

(51) Int. Cl. B42F 13/12

(52) U.S. Cl. 402/75

(57) ABSTRACT

A file extension plate apparatus for a file folder, comprising vertically aligned pairs of stakes for the purpose of increasing the number of paper bundles readily visible to the user, and to allow the simple and uncomplicated accessibility, addition or extraction of pages or files therein. The stakes are preferably arranged in substantially horizontal groups of two, and upon each group of stakes at least one paper bundle may be attached. The file extension plate apparatus includes a primary file plate affixed to a file folder front, back, or partition, and a series of extension plates attached thereto in an overlapping fashion. The vertically aligned pairs of stakes extend outward from the series of extension plates and the primary file plate, and are each configured to receive a paper bundle such that each bundle is accessible to a user without disturbing the other bundles.

### RELATED APPLICATION

This application claims priority from the United States provisional application with Ser. No. 60/830,523, which was filed on 18 Jul. 2006. The disclosure of that provisional application is incorporated herein by reference as if set out in full.

### FIELD OF THE INVENTION

The present invention relates to file organizational office supplies, specifically office file folders.

### GENERAL BACKGROUND

Organization supplies have a long history and are well known for their use in keeping documents in place, accessible and in an order that can make one document easy to retrieve from a selection of many. Paper and office supplies are often stored in folders or binders. To that end, they are often perforated by a hole puncher and threaded over a stake attached to the folder or binder.

Since the first patents on the paper hole punch from approximately 150 years ago, various standards have been accepted and are commonly used for the positioning of holes in documents. Thus, typical document file folders now comprise self-adhesive or mechanical stakes or paper retention clips specifically designed to accommodate the punched holes in a document. The stake may be a simple spike, prong, or even a fastener such as the common two-piece paper retention clip manufactured by ACCO. The stake oftentimes comprises a prong that after the top document has been threaded accepts a washer to keep the bundle of documents held tightly together. Regardless of the type of stake used, the stake is generally mechanically threaded through holes in the file folder, or mechanically or adhesively affixed to the folder.

A problem arises as a conventional file folder grows over time to contain several groupings of documents within it. For these cases, partitioned file folders are generally used, wherein the file opens in a book-like fashion to reveal several partitioned sections, each with stakes for attaching a bundle of documents. If the traditional file folder is used, the folder often becomes quite thick and unmanageable. Worse, to add a document to a section buried beneath the topmost documents, all documents above the document in question must first be removed. This approach is both time-consuming and creates a likelihood of improper removal and refiling of papers.

In addition, to access and review a threaded document upon which many additional documents have been threaded, all documents on top of the document to be reviewed must be flipped up and out of the way. When very large numbers of documents are used, the flexibility of the large bundle decreases to a point where frustration may occur.

While traditional file folders and pressboard classification folders are thus suitable for the particular purpose to which they address, they are not suitable for the purpose of providing a device that will allow a large number of bundles to each be readily visible when attached to a single parent file folder. They also do not allow the simple review, extraction, or insertion of documents buried beneath many other documents.

An additional problem originating from the above scenario is brought about by the repeated removal and rethreading of large number of documents is mechanical wear and tear on the file folder, the stakes, and on the documents themselves.

One solution that does require the use a multi-partitioned folder calls for the splitting of the large bundle of documents into several through the insertion of large or stiff pieces of stationary or plastic therein. These dividers serve to let the user know that one section of documents has ended and a new section is starting. While this solution eases the locating of one file within the large bundle, it does not alleviate all of the aforementioned problems inherent in dealing with a very large stack of documents bound together.

In view of the foregoing disadvantages inherent in the known types of organizational file supplies now present in the prior art, it is thus a primary object of the invention to provide a file extension plate apparatus for a file folder, thereby allowing multiple bundles to be stored, accessed and modified in one file folder.

It is an additional object of the invention to provide a file extension plate apparatus for a file folder, thereby allowing a large number of documents to be accessed while reducing wear and tear on the documents and file folder in which they are contained.

It is an additional object of the invention to provide a file extension plate apparatus for a file folder to increase the number of bundles readily visible when attached to a single file folder partition.

It is an additional object of the invention to provide a file extension plate apparatus for a file folder, thereby allowing a user to add easily identifiable tabbed bundles to a common parent file holder partition by at least tripling the amount of file page perimeter available for labeling and tabbing.

It is an additional object of the invention to provide a file extension plate apparatus for a file folder, thereby allowing a user to easily access, add and remove documents from a paper bundle attached to a first extension plate without disturbing the order of the paper bundles in the additional extension plates.

It is an additional object of the invention to provide a file extension plate apparatus for a file folder to increase the level of the file folder's organization.

Additional objects and advantages of the present invention will become obvious to the reader and it is intended that these objects and advantages are within the scope of the present invention.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 is an exploded perspective view of a first embodiment of the present invention with phantom lines showing the alignment of several components.

FIG. 2 is a condensed view of the first embodiment of the present invention in a first configuration.

FIG. 3 is a condensed view of the first embodiment of the present invention in a second configuration.

FIG. 4 is a condensed view of the first embodiment of the present invention with bundles of paper attached thereto.

FIG. 5 is an exploded perspective view of a second embodiment of the present invention with phantom lines showing the alignment of several components.

FIG. 6 is an exploded perspective view of a third embodiment of the present invention with phantom lines showing the alignment of several components.

FIG. 7 is an exploded perspective view of a fourth embodiment of the present invention with phantom lines showing the alignment of several components.

FIG. 8 is an exploded perspective view of a fifth embodiment of the present invention with phantom lines showing the alignment of several components.

FIG. 9 is an exploded perspective view of a sixth embodiment of the present invention with phantom lines showing the alignment of several components.

FIG. 10 is a perspective view of a seventh embodiment of the present invention.

FIG. 11 is a perspective view of the seventh embodiment of the present invention with bundles of paper attached thereto.

FIG. 12 is a right side view of the seventh embodiment of the present invention with bundles of paper attached thereto.

### SUMMARY OF THE INVENTION

The present invention is a file extension plate apparatus for a file folder, comprising a plurality of vertically aligned pairs of stakes for the purpose of increasing the number of primary paper bundles readily visible to the user. For purposes of this patent application, all of the papers threaded over a common stake (or stakes) that do not have a partition (such as a file extension plate) between them shall be referred to as a bundle. The stakes are preferably arranged in substantially horizontal pairs of two, and upon each pair of stakes one paper bundle may be attached. Additional papers may be added or removed from one paper bundle without disturbing the papers in the other bundles.

The file extension plate apparatus is preferrably made from folder-type cardboard; however, it may also be made from a variety of other fibrous materials and/or plastic materials. The apparatus comprises at least two pairs of stakes, with one pair of folder stakes preferably being mounted along the upper edge of the respective folder panel and another pair of extension stakes mounted in a lower position, but substantially vertically in line with the folder stakes. Together, the stakes act as foldable retaining tabs to secure documents as is well known in the art.

The general purpose of the present invention, which will be described subsequently in greater detail, is to provide a new file extension plate apparatus that has many of the advantages of the file organizational supplies mentioned heretofore and many novel features.

The novel features are brought about by the stepped nature of the plates, wherein a primary bundle of documents is attached to a first,stepped plate, a second bundle of documents is attached to a second stepped plate, and a third bundle of documents is attached to a third stepped plate, and so forth. No limitation is presented as to the number of overlapping bundles that may be attached. While in theory the design can work with an unlimited number of file extension plates, in practice the number of file extension plates (and related bundles) is not likely to exceed eight.

The file extension plate apparatus comprises a plurality of thin planar rectangular panels of varying lengths, each panel further comprising an end that attaches to either the folder panel or any file extension plates underneath it. Each of the file extension plates further comprises a pass-through hole for the threading of a common stake, to which additional documents will be threaded. In a preferred embodiment of the invention the pass-through hole comprises a slit, and each file extension plate comprises a pair of slits as each of two ends. In this preferred embodiment of the invention, the distance between the two slits making up a pair of slits accommodates International Standard ISO 838 or a common office 2-hole punch.

### DETAILED DESCRIPTION OF THE INVENTION

The present invention is a file extension plate apparatus for a file folder, comprising a plurality of stakes for the purpose of increasing the number of primary paper bundles readily visible to the user. The stakes are preferably arranged in substantially horizontal groups of two, and upon each group of stakes one paper bundle may be attached. Additional papers may be added or removed from one paper bundle without disturbing the others.

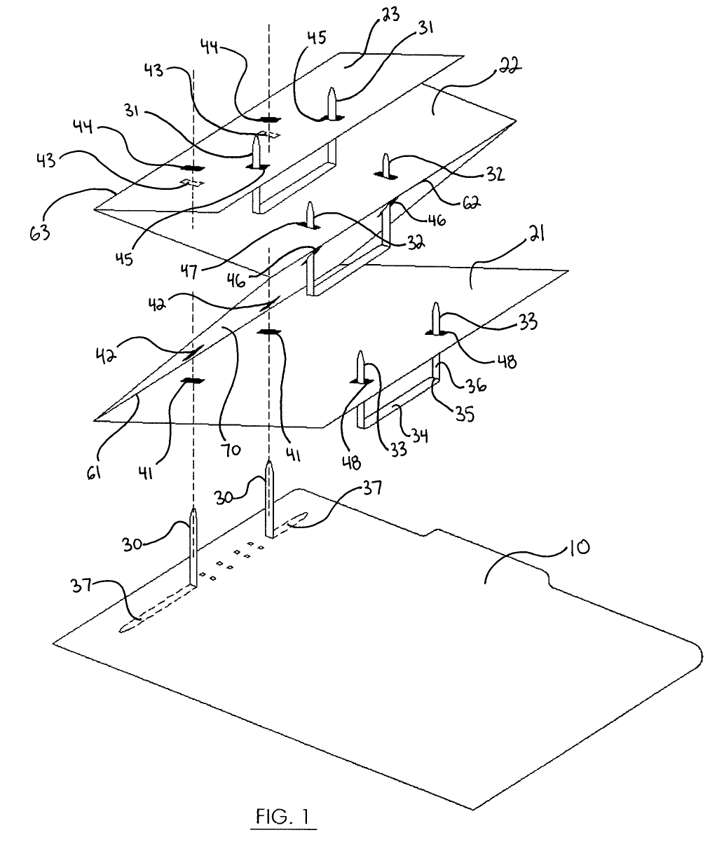

Referring now to FIG. 1, the present invention is a file extension plate preferably used with a folder having a pair of opposed, attached side panels separated by a fold line. Although FIG. 1 depicts a right side panel 10, the present invention may be utilized on a left side panel, both side panels, front and back panels, or any folder partition within a file folder as is commonly understood in the art. Additionally, other types of folders, such those with several compartments and retaining pockets (not shown) may include a panel to which file extension plate may be attached thereto.

In this first and preferred embodiment, the file extension plate comprises three extension plates connected to said panel 10. First extension plate 21 is in overlapping configuration with second extension plate 22, which in turn is in overlapping configuration with third extension plate 23. A connector 70 (shown only in FIG. 1) connects said first extension plate 21 to said second extension plate 22. In the embodiment depicted in FIGS. 1-4, a first hinge 61 connects first extension plate 21 to connector 70, a second hinge 62 connects said connector 70 to second extension plate 22, and a third hinge 63 connects second extension plate 22 to third extension plate 23. The overall effect is an accordion type folding as most clearly depicted in FIG. 1 that allows the file extension plate be constructed from a single piece of material.

While the overall length and width of the extension plates varies, each overlapping extension plate's length is at least as long as the extension plate that overlaps it. This overlapping configuration is key to ensure the multiple pairs of stakes (retainer clips) are exposed and that exposed perimeter of the paper bundles is maximized. As shown in FIG. 1, the length of third extension plate 23 is not as long as the length of second extension plate 22, which in turn is not as long as the length of first extension plate 21.

In this and all embodiments, the extension plate may be composed of metal, cardboard, common manila folder stock, plastic, or any other tear resistant (high tensile strength) material of varying thickness.

The file extension plate comprises at least two pairs of stakes, wherein at least one pair is a pair of folder stakes 30, each preferably being mounted along the upper edge of panel 10, and wherein at least one other pair are extension stakes. Folder stakes 30 may be pre-fabricated as an integral part of panel 10 or may be threaded therethrough by the user. In FIG. 1, three sets of extension stakes are depicted and labeled first extension stakes 31, second extension stakes 32, and third extension stakes 33.

While the generic term stakes is used for simplicity, in practice a wide range of paper fasteners may be applicable to the present invention for this and all embodiments. U.S. Pat. No. 1,094,951 to Washburne, U.S. Pat. No. 2,324,004 to Kriegsman, U.S. Pat. No. 1,978,569 to Dayton, and U.S. Pat. No. 3,371,829 to Corey disclose several of such fasteners. Together, one pair of stakes may also be referred to as mounting tabs or document retention tabs, in accordance with their general well-known use of securing papers. Each stake is preferably made from a generally flat, flexible piece of material, such as a pliable metal or polypropylene. Returning now to FIG. 1, in a preferred embodiment each stake 30 includes an attachment surface 34 and a threading surface 36, separated by a fold line 35. The attachment surface 34 is attached to the side panel 10 or to the file extension plate. The threading surface 36 is free to pivot relative to the respective attachment surface 36 about the fold line 35.

All stakes are preferably threaded through pairs of elongated mounting slots. The pairs of mounting slots are preferably aligned to correspond with the holes made by a standard centered two-hole top punch office appliance for 8.5″×11″ paper. This corresponds to the dimensions of locations of filing holes punched in paper according to International Standard ISO 838.

Due to the folding nature of the file extension plate in this embodiment, the various stakes will be threaded through varying numbers of mounting slots. Beginning with folder stake 30, this stake is threaded through folder stake first mounting slot 41, folder stake second mounting slot 42, folder stake third mounting slot 43, and folder stake fourth mounting slot 44. Turning now to first extension stake 31, this stake is threaded through first extension stake mounting slot 45. Second extension stake 32 is threaded through second extension stake first mounting slot 46 and second extension stake second mounting slot 47. Third extension stake 33 is threaded through third extension stake mounting slot 48. Each of the two slots in a pair are substantially horizontally aligned with said panel 10, and are spaced apart by a medial portion (unlabeled).

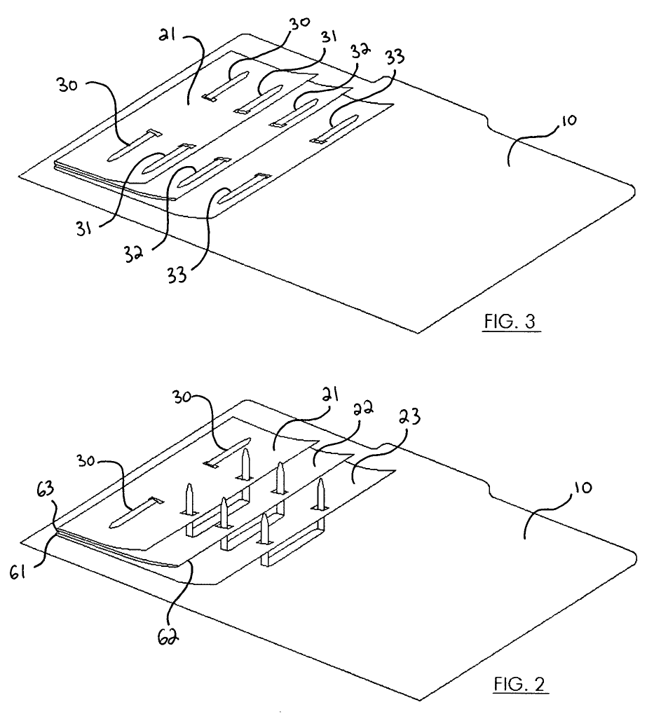

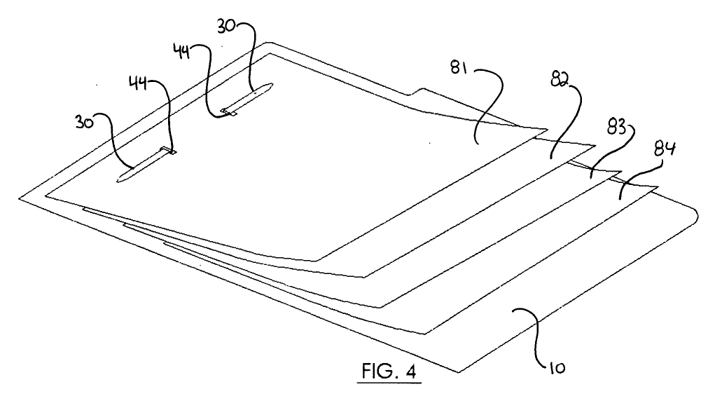

In use, all embodiments disclosed in this application allow for the threading of loose papers (preferably arranged into paper bundles) onto each of the pairs of stakes. Referring now to FIG. 4, multiple paper bundles are depicted attached. A paper bundle may comprise as few as one document, as shown in FIG. 4, but typically comprises numerous documents. In each case, the paper bundle is threaded through one pair of stakes. After mounting the paper bundle upon the stakes by threading the stakes through holes on the bundles, the threading surface 36 of the stake may be bent into juxtaposition with said medial portion between the slots, or bent outward away from the medial portion. In either case, in a preferred use the stake is bent such that a portion of the threading surface 36 is substantially planar with the paper bundle through which is threaded. FIG. 2 shows the extension stakes in the upright position and FIG. 3 depicts the extension stakes after they have been folded down. In FIGS. 2 and 3, paper bundles are not attached.

Referring back to FIG. 4, a first paper bundle 81 is attached and secured by folder stakes 30. A second paper bundle 82 is attached and secured by first extension stakes 31 (not visible in FIG. 4). A third paper bundle 83 is attached and secured by second extension stakes 32 (not visible in FIG. 4). A fourth paper bundle 84 is attached and secured by third extension stakes 33 (not visible in FIG. 4). In use, papers may be threaded to the second, third or any additional pair of extension stakes. To retrieve a paper from one of the additional pairs of extension stakes, the papers threaded through the stakes above may be pivoted away from the pair of extension stakes in question.

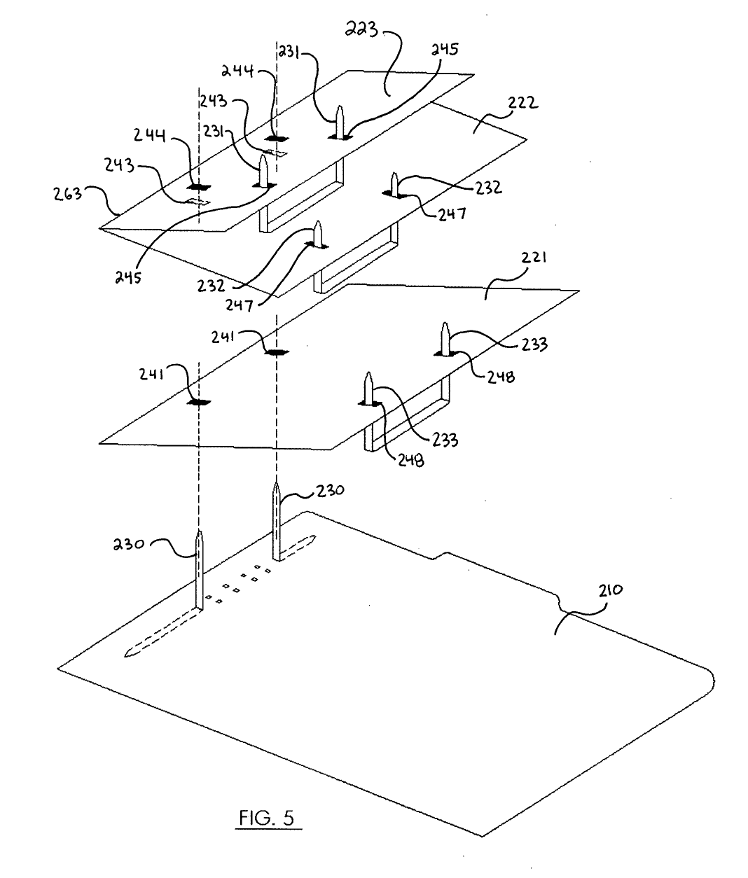

In second embodiment of the invention, the file extension plate is very similarly constructed to that in the preferred embodiment. Referring briefly to FIG. 1, a main difference between the embodiment of FIG. 1 and the second embodiment (FIG. 5) is that connector 70, as well as said first hinge 61 and 62, is removed from the second embodiment. As connector 70 is essential to the accordion-like folding that allows the extension plate to comprise a single sheet of folded material, the extension plate is thus composed of two parts, as shown in FIG. 5. A first extension plate 221 is identical to extension plate 21 in the preferred embodiment. Additionally, second and third extension plates 222 and 223 are identical to extension plates 22 and 23 in the preferred embodiment. Hinge 263 connects second extension plate 222 to third extension plate 223.

In this embodiment, folder stake 230, attached to panel 210, is threaded only through folder stake first mounting slot 241, folder stake second mounting slot 243 and folder stake third mounting slot 244. For purposes of clarity, FIG. 5 depicts folder stake second mounting slot 243 as visible through the third extension plate 223. A dashed line indicates the pathway through which folder stake 230 is threaded. First extension stake 231 is threaded through first extension stake mounting slot 245, similar to the first extension stake in the preferred embodiment of the invention. Likewise, third extension stake 233 is threaded through third extension stake mounting slot 248 just as in the preferred embodiment of the invention. Second extension stake 232 is only threaded through second extension stake second mounting slot 247.

Although two components are needed for the manufacture of the extension plate according to this alternative embodiment, the advantage in this embodiment is that ultimately less material is required to be used.

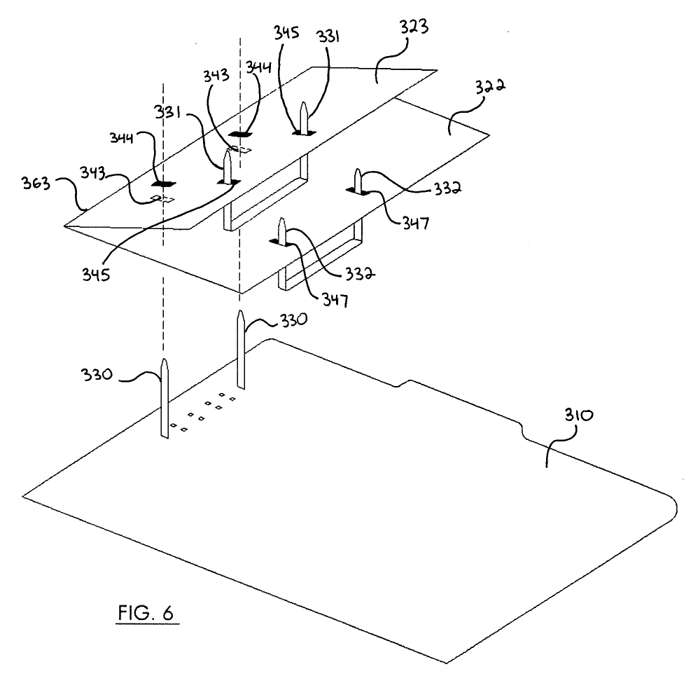

Turning now to FIG. 6, a third embodiment of the invention is disclosed. In this simplified embodiment only a two pairs of extension stakes are utilized. First extension plate 322 and second extension plate 323 is similar to extension plates 22 and 23 in the preferred embodiment. Hinge 363 connects first extension plate 322 to second extension plate 323.

In this embodiment, folder stake 330, attached to panel 310, is threaded only through folder stake first mounting slot 343 and folder stake second mounting slot 344. For purposes of clarity, FIG. 6 depicts folder stake first mounting slot 343 as visible through the second extension plate 323. A dashed line indicates the pathway through which folder stake 330 is threaded. First extension stake 331 is threaded through first extension stake mounting slot 345, similar to the first extension stake in the preferred embodiment of the invention. Second extension stake 332 is only threaded through second extension stake second mounting slot 347.

Although two components are needed for the manufacture of the extension plate according to this third embodiment, the advantage in this embodiment is that ultimately less material is required to be used.

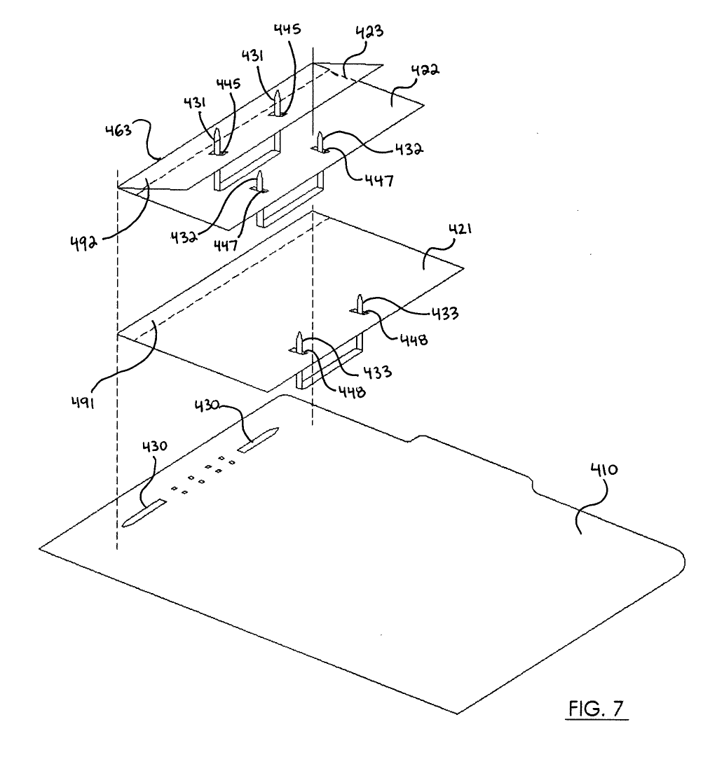

In a fourth embodiment of the invention as depicted in FIG. 7, first extension plate 421 only includes one pair of mounting slots. Third extension stake mounting slots 448 accept third extension stakes 433. Thus, folder stakes 430, do not thread through first extension plate 421. Rather, an adhesive strip 491 secures first extension plate 421 to panel 410. Similarly, second extension plate 422 is secured to first extension plate 421 by a second adhesive strip 492 on its underside. In both cases, any type of compound that adheres of bonds two items together can be used, including but not limited to natural adhesives, synthetic adhesives, drying adhesives, contact adhesives, thermoplastic adhesives, reactive adhesives, light curing adhesives, and pressure sensitive adhesives.

Second extension stakes 432 extend through second extension stake mounting slots 447 on said second extension plate 422. Finally, first extension stake 431 is threaded through first extension stake mounting slot 445 on said third extension plate 423. Similar the preferred embodiment, a hinge 463 allows second and third extension plates 422 and 423 to be constructed from one piece of material.

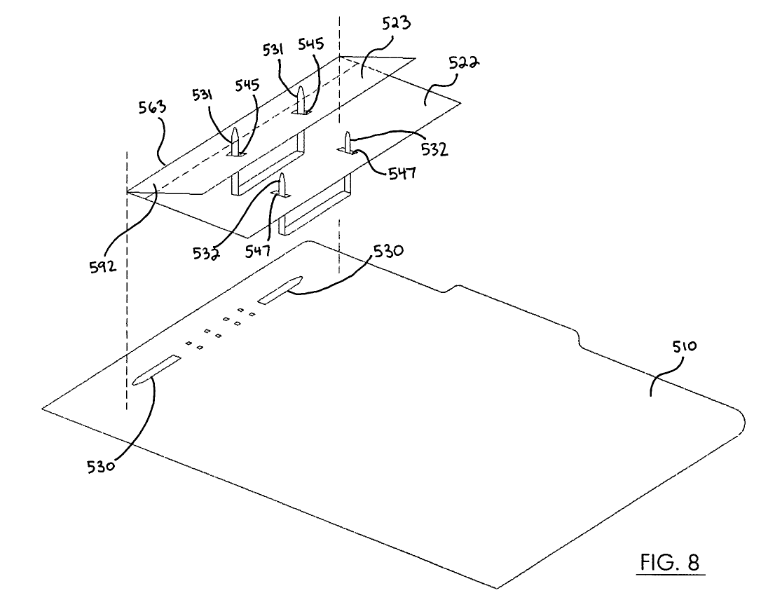

In a fifth embodiment, depicted in FIG. 8, only two extension plates are used, and are formed from a single piece of material folded onto itself along hinge 563. Like in the fourth embodiment described above, an adhesive strip 592 secures first extension plate 522 to panel 510. As in the fourth embodiment, folder stakes 530 do not thread through first extension plate 522.

Second extension stakes 532 extend through second extension stake mounting slots 547 on said first extension plate 522. Finally, first extension stake 531 is threaded through first extension stake mounting slot 545. Similar the preferred embodiment, hinge 563 allows second and third extension plates 422 and 423 to be constructed from one piece of material.

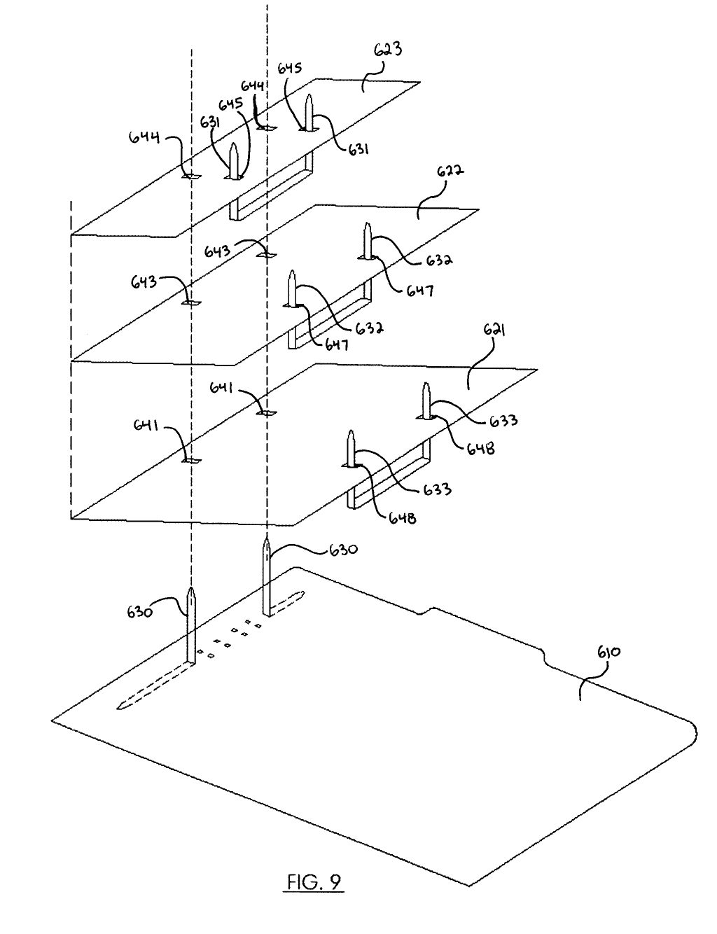

In a sixth embodiment, depicted in FIG. 9, the extension plate comprises three detached extension plates. The first extension plate 621, second extension plate 622, and third extension plate 623 in this embodiment are connected to one another only by file stake 630, which extends through folder stake first mounting slot 641, folder stake second mounting slot 643, and folder stake third mounting slot 644. The three extension plates are thus secured to panel 610. First extension plate 621 is seen in overlapping configuration with second extension plate 622, which in turn is depicted in overlapping configuration with extension plate 623. In this and all embodiments, the extension plate may be composed of metal, cardboard, common manila folder stock, plastic, or any other tear resistant (high tensile strength) material of varying thickness.

Each extension plate comprises two pairs of elongated mounting slots substantially horizontally aligned. First extension plate 621 comprises folder stake first mounting slots 641 and third extension stake mounting slots 648. Second extension plate 622 comprises folder stake second mounting slots 643 and second extension stake mounting slots 647. Third extension plate 623 comprises folder stake third mounting slots 644 and first extension stake mounting slots 645. First extension stake 631 extends through first extension stake mounting slot 645. Second extension stake 632 extends through second extension stake mounting slot 647. Third extension stake 633 extends through third extension stake 648.

While the overall length and width of sheet-like extension plates varies, each overlapping extension plate's length should be at least as long as the extension plate the overlaps it. This overlapping configuration is key to ensure the multiple pairs of stakes (retainer clips) are exposed and ready for use. As shown in FIG. 9, the length of extension plate 623 is not as long as the length of extension plate 622, which in turn is not as long as the length of extension plate 621.

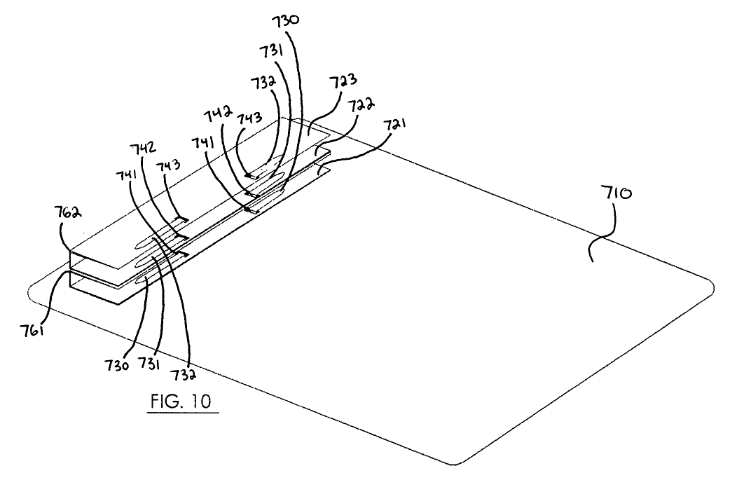

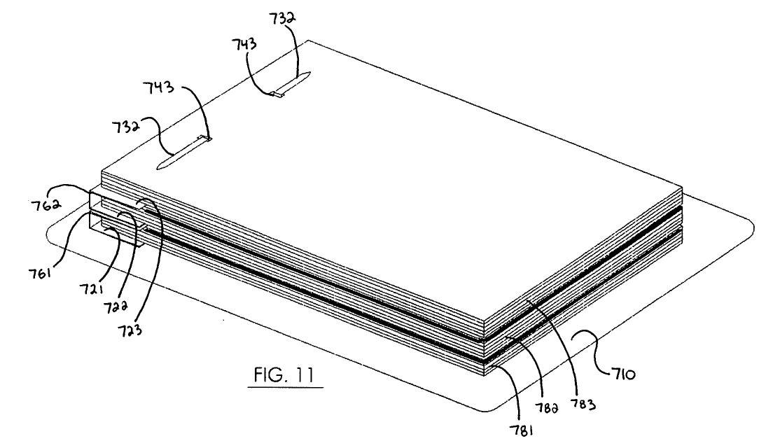

In a seventh embodiment of the invention, the file extension plates are positioned directly on top of one another above panel 710. See. FIGS. 10-12. Here, a single three-tiered rigid structure is flexible about two hinges. A first hinge 761 connects a first extension plate 721 to a second extension plate 722. A second hinge 762 connects second extension plate 722 to third extension plate 723. Threaded through each extension plate are stakes that can hold document bundles similarly in fashion to those bundles held by previous embodiments of the invention. A pair of folder stakes 730 is threaded through a pair of first extension plate mounting slots 741 in said first extension plate 721. A pair of first extension plate stakes 731 is threaded through a pair of second extension plate mounting slots 742 on said second extension plate 722. A pair of second extension plate stakes 732 is threaded through a pair of third extension plate mounting slots 743 ion said third extension plate 723. Because the mounting slots are substantially vertically aligned as shown, the extension plates may be stacked vertically, yet still allow individual document bundles to be edited by the user without disturbing the order of the other document bundles.

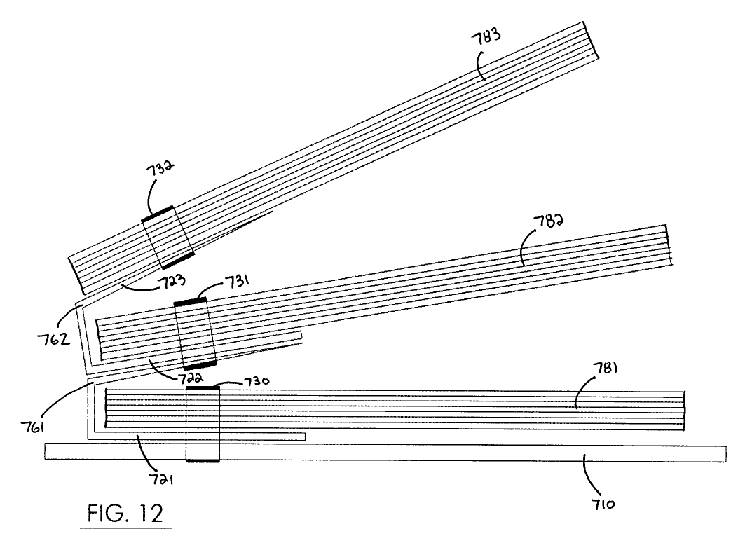

FIGS. 11 and 12 depict a first document bundle 781 held in place against first extension plate 721. Document bundle 782 is affixed to second extension plate 722 and a third document bundle 793 is held in place against a third extension plate 723.

With respect to the above description then, it is to be realized that the disclosed equations, figures and charts may be modified in certain ways while still producing the same result claimed by the Applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A file folder comprising:
a. a front panel and a back panel joined by a fold line;
b. a partition panel;
c. wherein at least one of said panels comprises a file extension plate apparatus integral therewith, and wherein said file extension plate apparatus comprises:
i. a plurality of substantially horizontally and substantially vertically aligned mounting slots adapted for receiving document retaining tabs, and wherein at least one of said mounting slots is in overlapping relation to at least one other of said mounting slots.

2. The file folder according claim 1 wherein said plurality of mounting slots comprises at least a first and second substantially vertical row of mounting slots, and wherein at least three of said mounting slots in said first substantially vertical row of mounting slots aligns horizontally with at least three of said mounting slots in said second substantially vertical row of mounting slots, thereby composing at least three pairs of horizontally aligned mounting slots.

3. The file folder according to claim 2 wherein said file extension plate apparatus is adapted to accept at least three partially overlapping bundles of 8.5 inch by 11 inch paper.

4. The file folder according to claim 1 wherein said file extension plate apparatus is adapted to accept at least three partially overlapping bundles of 8.5 inch by 11 inch paper.

5. The file folder according to claim 1 wherein said file extension plate apparatus comprises a single sheet having accordion-like folds.

6. The file folder according to claim 5 wherein one terminal fold of said sheet is affixed to said at least one of said panels.

7. The file folder according to claim 6 wherein said plurality of mounting slots comprises at least a first and second substantially vertical row of mounting slots, and wherein at least three of said mounting slots in said first substantially vertical row of mounting slots aligns horizontally with at least three of said mounting slots in said second substantially vertical row of mounting slots, thereby composing at least three pairs of horizontally aligned mounting slots.

8. The file folder according to claim 7 wherein said file extension plate apparatus is adapted to accept at least three partially overlapping bundles of 8.5 inch by 11 inch paper.

9. The file folder according to claim 8 wherein said file folder is adapted to accept at least three partially overlapping bundles of 8.5 inch by 11 inch paper.

10. The file folder according to claim 6 wherein said file extension plate apparatus is adapted to accept at least three partially overlapping bundles of 8.5 inch by 11 inch paper.

11. The file folder according to claim 10 wherein said file folder is adapted to accept at least four partially overlapping bundles of 8.5 inch by 11 inch paper.

12. A file folder comprising:
a. a plurality of panels, wherein at least one of said panels comprises:
i. a file extension plate apparatus integral therewith;
ii. a first substantially vertical row of mounting slots punched through said plate; and
iii. a second substantially vertical row of mounting slots punched through said plate, wherein at least three of said mounting slots in said first substantially vertical row of mounting slots aligns horizontally with at least three of said mounting slots in said second substantially vertical row of mounting slots, thereby composing at least three pairs of horizontally aligned mounting slots; and
b. wherein each of said three pairs of horizontally aligned mounting slots has a foldable stake projecting outward and threaded therethrough, said foldable stakes aligned in horizontal pairs.

13. The file folder according to claim 12 wherein said file folder is adapted to accept at least three partially overlapping bundles of 8.5 inch by 11 inch paper.

14. The file folder according to claim 12 wherein said file extension plate apparatus comprises a single sheet having accordion-like folds.

15. The file folder according to claim 14 wherein one terminal fold of said sheet is affixed to said at least one of said panels.

16. The file folder according to claim 15 wherein said file folder is adapted to accept at least three partially overlapping bundles of 8.5 inch by 11 inch paper.

17. A method of manufacturing a file folder comprising:
a. Providing a planar substrate folded substantially 180 degrees at least once in a vertical direction and further comprising:
i. a first substantially vertically aligned row of mounting slots punched through said substrate; and
ii. a second substantially vertically aligned row of mounting slots punched through said substrate, wherein at least three of said mounting slots in said first substantially vertically aligned row of mounting slots aligns horizontally with at least three of said mounting slots in said second substantially vertically aligned of mounting slots, thereby composing three pairs of horizontally aligned mounting slots; and
b. wherein each of said three pairs of horizontally aligned mounting slots has a foldable stake projecting outward and threaded therethrough, said foldable stakes aligned in horizontal pairs.

18. The method of manufacturing a file folder according to claim 17, the method further comprising providing a file folder comprising two substrate slots aligned with one of said pairs of horizontally aligned mounting slots.

19. The method of manufacturing a file folder according to claim 18, wherein a joining means connects said first substantially vertical row of mounting slots and said second substantially vertical row of mounting slots, and wherein said joining means is a continuous flat sheet.

20. A file folder comprising:
a. a plurality of panels, wherein at least one of said panels comprises a file extension plate apparatus integral therewith, said file extension plate apparatus comprising:
i. a plurality of file extension plates positioned directly above said panel, wherein at least two file extension plates are both directly above and aligned with at least one file extension plate, and wherein said file extension plates comprise substantially horizontally aligned mounting slots punched therethrough;
ii. a first hinge connecting a first file extension plate to a second file extension plate;
iii. a second hinge connecting a second file extension plate to a third file extension plate; and
iv. stakes threaded through each of said plurality of file extension plates capable of holding document bundles.

21. The file folder according to claim 20 wherein said file folder is adapted to accept at least three substantially overlapping bundles of 8.5 inch by 11 inch paper.

22. The file folder according to claim 20 wherein each of said plurality of file extension plates comprises at least two of said substantially horizontally aligned mounting slots arranged in pairs, and wherein two of said pairs are both directly above at least one of said pairs.

23. The file folder according to claim 22 wherein said file folder is adapted to accept at least three substantially overlapping bundles of 8.5 inch by 11 inch paper.
